(19) United States
(12) Patent Application Publication
(10) Pub. No.: US 2026/0175791 A1
(43) Pub. Date: Jun. 25, 2026

(54) VEHICLE CAMERA MODULE SYSTEM

(71) Applicant: SL Mirrortech Corporation, Siheung-si (KR)

(72) Inventors: Yonghwan KIM, Siheung-si (KR); Yonghei KIM, Siheung-si (KR); Youngsu NAM, Siheung-si (KR); Sooin LEE, Siheung-si (KR); Yeongkook CHO, Siheung-si (KR)

(21) Appl. No.: 19/390,311

(22) Filed: Nov. 14, 2025

(30) Foreign Application Priority Data
Dec. 20, 2024 (KR) 10-2024-0192741

(51) Int. Cl. B60R 11/04; B60R 11/00; G03B 17/56

(52) U.S. Cl. CPC B60R 11/04; G03B 17/561; B60R 2011/004; B60R 2011/0085

(57) ABSTRACT

A vehicle camera module system includes: a base including a fixing part; a cover unit including a lower cover penetrated by the fixing part, and an upper cover coupled to the lower cover; a camera module disposed in the cover unit; a motor housing disposed in the cover unit and penetrated by the fixing part, wherein the motor housing is rotatable with respect to the base; a driving unit that provides power to cause relative rotation of the motor housing about the fixing part; and a fixing module configured to be fixed to the fixing part to allow the relative rotation of the motor housing in response to the power of the driving unit being transmitted in an electric mode, and to rotate with the motor housing about the fixing part in response to an external force being exerted in a manual mode.

### CROSS-REFERENCE TO RELATED APPLICATION

This application claims priority from Korean Patent Application No. 10-2024-0192741 filed on Dec. 20, 2024, which is incorporated herein by reference in its entirety.

### BACKGROUND

### 1. Technical Field

The present disclosure relates to a vehicle camera module system, and more particularly, to a vehicle camera module system that is installed on a side of a vehicle to capture images to a side or rear of the vehicle and is arranged to be foldable on a base.

### 2. Description of the Related Art

In general, an inside mirror is installed in an interior of a vehicle to allow the driver to perceive the rear situations of the vehicle, and outside mirrors are installed on both outer sides of the vehicle to allow the driver to perceive the side and rear situations of the vehicle. Through the field of view secured by the inside mirror or the outside mirrors, the driver can perceive surrounding vehicles, pedestrians, and the like and perform operations such as reversing, passing, and lane changes.

Recently, a camera module system (CMS) including a camera module has been applied in place of outside mirrors in order to reduce air resistance during driving and to lower the possibility of damage due to external impacts. Since images of the surroundings of the vehicle acquired by the CMS are displayed through a display device provided inside the vehicle, the driver can easily perceive the surroundings of the vehicle.

Meanwhile, during operation, the CMS remains unfolded so that the driver can perceive the surroundings of the vehicle, but when the vehicle is parked or passes through a narrow space, it is necessary for the CMS to be folded toward the side of the vehicle to prevent damages to the CMS and to secure the surrounding space of the vehicle. In this case, the driver may rotate the CMS by using an actuator or manually.

However, a neck portion that connects the CMS to the vehicle may deteriorate from aesthetic appearance, and due to the inherent thickness of the actuator that enables automatic rotation, there is a difficulty in realizing a slim form factor.

### SUMMARY

One objective of the present disclosure is to provide a vehicle camera module system that is slim in design, installed on a side of a vehicle to capture a side or rear views of the vehicle, and arranged to be foldable on a base.

The objectives of the present disclosure are not limited to those mentioned above, and other objectives not explicitly stated will be clearly understood by those skilled in the art based on the following description.

According to an aspect of the present disclosure, a vehicle camera module system may include a base, a first side of which is connected to a vehicle and a second side of which includes a fixing part that forms a rotation shaft; a cover unit including a lower cover arranged such that a first side thereof is penetrated by the fixing part, and an upper cover coupled to an upper portion of the lower cover; a camera module provided at a second side of the cover unit; a motor housing disposed in the cover unit and penetrated by the fixing part, wherein the motor housing is arranged to be rotatable within a predetermined angular range with respect to the base; a driving unit that provides power to cause relative rotation of the motor housing about the fixing part; and a fixing module configured: (i) in an electric mode, to be fixed to the fixing part to allow the relative rotation of the motor housing with respect to the fixing module in response to the power of the driving unit being transmitted, and (ii) in a manual mode, to rotate along with the motor housing about the fixing part in response to an external force being exerted in a manual mode.

The driving unit may include: a motor that generates a rotational power; and at least one gear module to transmit the rotational power.

The fixing module may include: a driven gear disposed inside the motor housing and penetrated by the fixing part, and configured to engage with the at least one gear module; and an elastic member to bias the driven gear toward the base. The fixing module may further include a clip plate arranged to be penetrated by an end of the fixing part; and a clip that fixes the clip plate to the end of the fixing part. The elastic member may be disposed between the driven gear and the clip plate.

The fixing module may further include a torque plate arranged outside the motor housing and coupled with the driven gear.

One of the torque plate or the driven gear may include a protrusion that protrudes toward the other thereof, and the other may include a groove corresponding to the protrusion. The protrusion and the groove may be arranged such that their contact surfaces lie in a direction orthogonal to a circumferential direction of the driven gear.

The motor housing may include: a lower housing arranged below the driving unit; and an upper housing coupled to the lower housing, thereby surrounding the driving unit between the lower housing and the upper housing.

The lower housing may include a first stopper that protrudes to be inserted into the base and disposed near a through-hole, which is penetrated by the fixing part, formed in the lower housing.

The base may include: a middle plate from which the fixing part protrudes upward. A lower plate and an upper plate may be provided to accommodate the middle plate therebetween.

The upper plate or both the upper plate and the middle plate may include an arc-shaped first guide groove into which the first stopper is movably inserted, to restrict rotation of the motor housing within a predetermined angular range along the first guide groove.

The lower housing may include a second stopper that protrudes to be inserted into the torque plate and disposed near the through-hole formed in the lower housing.

The torque plate may include a second guide groove formed in an outer peripheral region of an upper surface thereof, and the second guide groove may be configured to limit a rotation range of the second stopper within a predetermined angular range when the motor housing is rotated in the electric mode.

The first stopper and the second stopper may be respectively arranged in non-overlapping ranges in a circumferential direction of the driven gear.

The first guide groove may be formed to have the predetermined angular range that is greater than the second guide groove.

The torque plate may include: a plurality of outer protrusions that protrude from an outer peripheral region of a lower surface of the torque plate at substantially equal intervals along a circumferential direction of the driven gear; and a first inner protrusion that protrudes from the lower surface at a radial position more inward than the outer protrusions. The middle plate may include: a plurality of outer grooves corresponding to the outer protrusions; and an inner groove corresponding to the first inner protrusion.

The outer protrusions and the outer grooves may be formed with inclined surfaces such that their contact surfaces are inclined with respect to the circumferential direction.

When the cover unit is rotated in the manual mode, the torque plate may be configured to be elastically spaced apart from the middle plate along the inclined surfaces, and to rotate about the fixing part together with the motor housing and the driven gear.

The middle plate may include a second inner protrusion configured to interfere with the first inner protrusion in a process in which the motor housing is rotated in a reverse folding direction from an unfolded state in the manual mode.

The first guide groove may be formed to have the predetermined angular range that is greater than the second guide groove by a range corresponding to an angular movement range of the first stopper in the reverse folding direction, which is opposite to a folding direction, from an unfolded state of the motor housing.

According to the vehicle camera module system of the present disclosure, the following advantages may be provided.

First, aesthetic appearance can be enhanced by configuring the portion that protrudes from the vehicle or the door of the vehicle to have a slimmer design.

Second, a folding structure can be implemented while maintaining a slim form factor.

Third, the vehicle camera module system can be driven in both electric and manual modes and can be automatically aligned to the unfolded state, which is a reference position.

Fourth, by improving the vehicle camera module system to have a slim form, effects such as reduction of wind noise and improvement in fuel efficiency and electric efficiency can be achieved.

It should be noted that the effects of the present disclosure are not limited to those described above, and other effects of the present disclosure will be apparent from the following description.

### BRIEF DESCRIPTION OF THE DRAWINGS

The detailed description of the exemplary embodiments of this application described below, as well as the summary described above, will be better understood when read in conjunction with the accompanying drawings. The drawings illustrate exemplary embodiments of the present disclosure for illustrative purposes. However, it should be understood that the application is not limited to the exact arrangements and means shown.

FIG. 1 is a perspective view illustrating a portion of a vehicle equipped with a vehicle camera module system according to an embodiment of the present disclosure.

FIG. 2 is a perspective view illustrating the vehicle camera module system illustrated in FIG. 1.

FIG. 3 is an exploded perspective view illustrating the vehicle camera module system illustrated in FIG. 2.

FIG. 4 is a cross-sectional view, taken along line A-A′ in FIG. 2, of the vehicle camera module system illustrated in FIG. 2.

FIG. 5 is an exploded perspective view illustrating a driven gear, a lower cover, and a torque plate of the vehicle camera module system illustrated in FIG. 3 as viewed from above.

FIG. 6 is an exploded perspective view illustrating the driven gear, the lower cover, and the torque plate of the vehicle camera module system illustrated in FIG. 5 as viewed from below.

FIG. 7 is a perspective view illustrating an unfolded state of the vehicle camera module system in FIG. 2, with a cover unit removed for illustration purposes.

FIG. 8 is a perspective view illustrating a partially folded state of the vehicle camera module system in FIG. 7 in an electric mode.

FIGS. 9 through 11 are cross-sectional views illustrating a folding process of the vehicle camera module system in FIGS. 7 and 8.

FIG. 12 is a perspective view illustrating a partially folded state of the vehicle camera module system in FIG. 7 in a manual mode.

FIGS. 13 through 15 are cross-sectional views illustrating a folding process of the vehicle camera module system in FIG. 12.

FIGS. 16 through 18 are cross-sectional views illustrating a reverse folding process from the unfolded state of the vehicle camera module system in the manual mode.

FIG. 19 is a cross-sectional view illustrating a folding process of the vehicle camera module system in FIG. 11 in the electric mode.

FIG. 20 is a cross-sectional view illustrating an unfolding process of the vehicle camera module system in FIG. 19 in the manual mode.

FIG. 21 is a cross-sectional view illustrating a state in which the vehicle camera module system in FIG. 19 is aligned in the electric mode after being unfolded in the manual mode.

FIG. 22 is a cross-sectional view illustrating a folding process of the vehicle camera module system in FIG. 15 in the manual mode.

FIG. 23 is a cross-sectional view illustrating an aligned state of the vehicle camera module system in FIG. 22 in the electric mode.

FIG. 24 is a cross-sectional view illustrating an unfolding process of the vehicle camera module system in FIG. 23 in the electric mode.

### DETAILED DESCRIPTION

The present disclosure is open to various modifications and includes various embodiments. Specific embodiments will be illustrated and described in the drawings. However, this is not intended to limit the present disclosure to such specific embodiments, and it should be understood to include all modifications, equivalents, and alternatives within the spirit and scope of the disclosure.

Terms including ordinal numbers such as first, second, etc., may be used to describe various components, but these components are not limited by these particular orders. These terms are used only to distinguish one component from another. For example, a second component can be named a first component without departing from the scope of the disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present. Conversely, when a component is said to be “directly connected to” or “directly coupled to” another component, there are no intervening components.

The terms used in this application are for the purpose of describing particular embodiments only and are not intended to limit the disclosure.

Unless the context clearly indicates otherwise, the singular forms include the plural forms as well.

In this application, the terms “comprising” or “having” are intended to specify the presence of stated features, numbers, steps, operations, elements, components, or combinations thereof, but do not preclude the presence or addition of one or more other features, numbers, steps, operations, elements, components, or combinations thereof.

Embodiments will hereinafter be described with reference to the accompanying drawings, wherein the same or corresponding components, regardless of the drawing numbers, are assigned the same reference numbers, and redundant descriptions will be omitted.

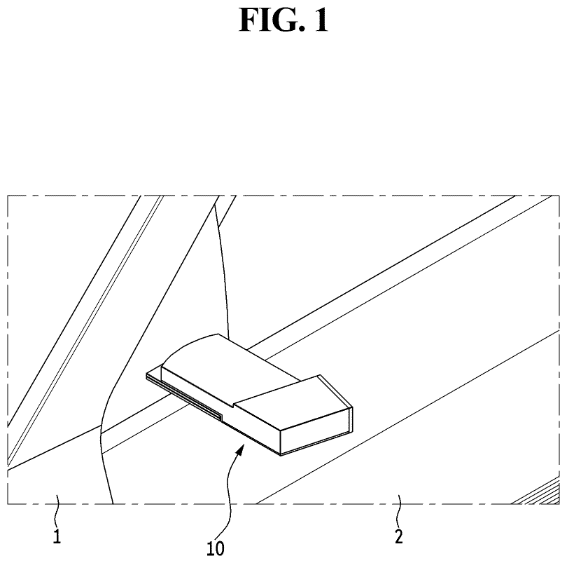

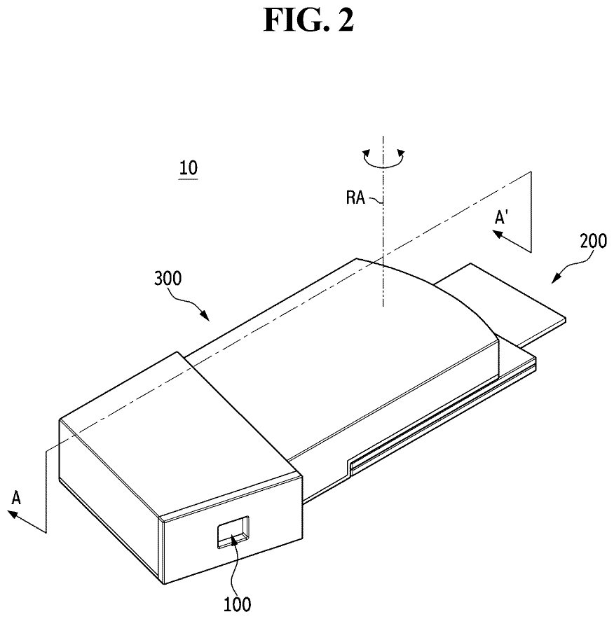

FIG. 1 is a perspective view illustrating a portion of a vehicle equipped with a vehicle camera module system according to an embodiment of the present disclosure, and FIG. 2 is a perspective view illustrating the vehicle camera module system illustrated in FIG. 1.

Referring to FIGS. 1 and 2, a vehicle camera module system 10 according to an embodiment of the present disclosure may be installed on both outer sides of a vehicle 1 to replace the function of a conventional side mirror. For example, the vehicle camera module system 10 may acquire images of a side or rear view of the vehicle 1 using a camera module (e.g., an imaging device) 100 and provide real-time images to a user, thereby offering a digital side mirror function.

The vehicle camera module system 10 is described, by way of example, as being installed in a region adjacent to an A-pillar and a door 2 on the left side (or driver side) of the vehicle 1, but the mounting position of the vehicle camera module system 10 according to the present disclosure is not limited thereto.

The vehicle camera module system 10 may include a base 200 and a cover unit 300.

One side of the base 200 may be fixed to the vehicle 1 or the door 2, and the other side coupled to the cover unit 300. A rotation axis RA may be arranged vertically between the base 200 and the cover unit 300, and the cover unit 300 may be rotatably coupled to the base 200 so as to allow relative rotation with respect to the rotation axis RA for folding and unfolding. A camera module 100 may be embedded in an outer end of the cover unit 300, and may acquire images toward the left side or the rear of the vehicle. The image captured by the camera module 100 may be displayed so that a user may view it in real time.

FIGS. 1 and 2 illustrate the structure in which the cover unit 300 is arranged on the left side of the vehicle 1 as an example. For the vehicle camera module system 10 arranged on the right side (i.e., passenger side) of the vehicle 1, the vehicle camera module system 10 may be configured to rotate in the opposite direction with respect to the rotation axis RA.

FIG. 2 illustrates the cover unit 300 in its unfolded state (e.g., spread-out or open position) with respect to the base 200. When the cover unit 300 rotates counterclockwise about the rotation axis RA, from the state shown in FIG. 2, the outer end of the cover unit 300 or the camera module 100 may be folded to be disposed close to the body of the vehicle 1 or the door 2.

The vehicle camera module system 10 may be implemented as a slim structure in which the maximum height of the cover unit 300, which is the highest part of the vehicle camera module system 10, may be about 30 mm or less.

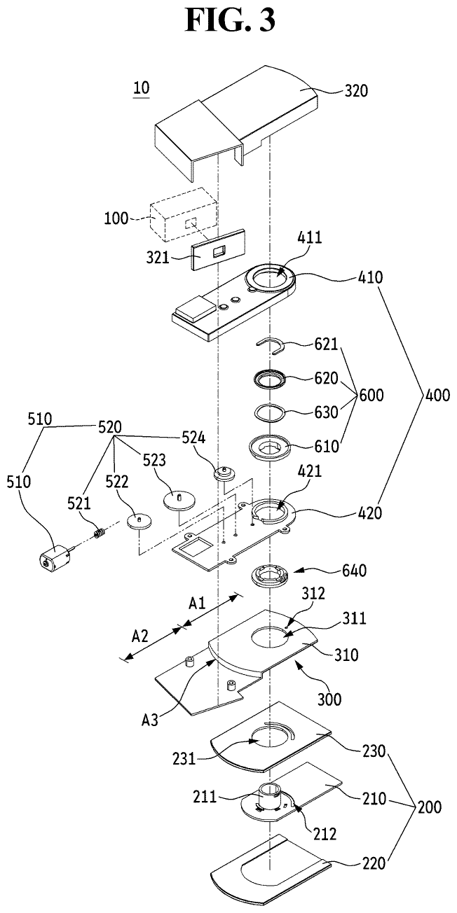

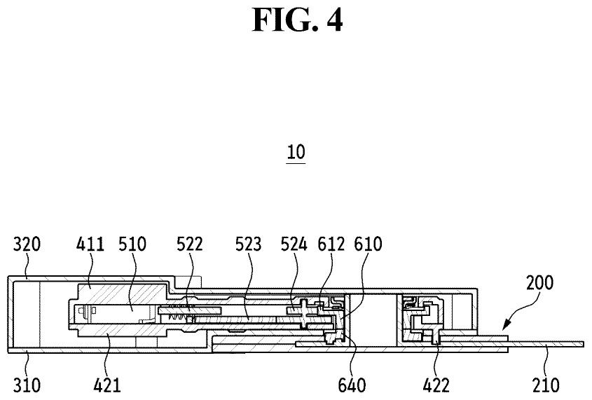

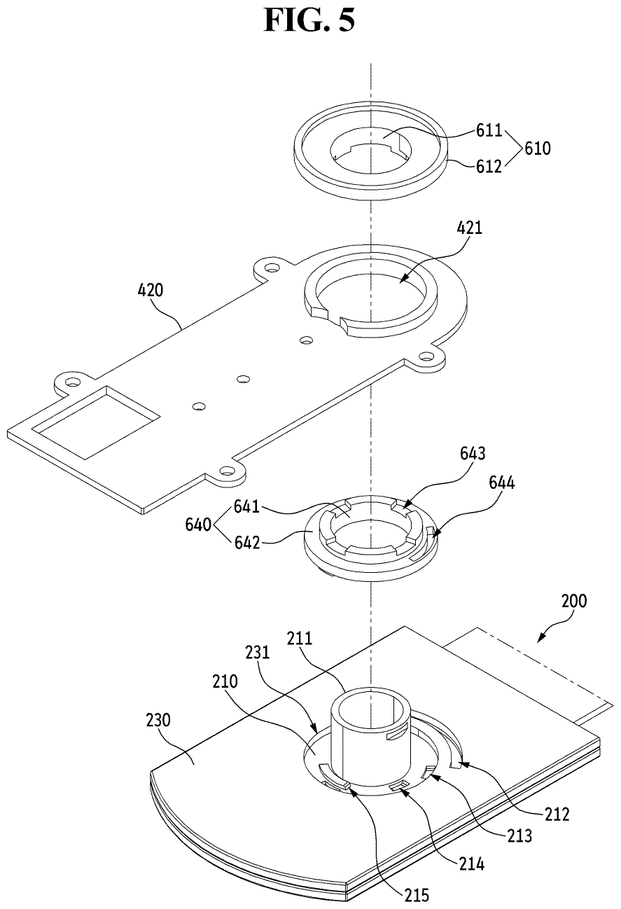

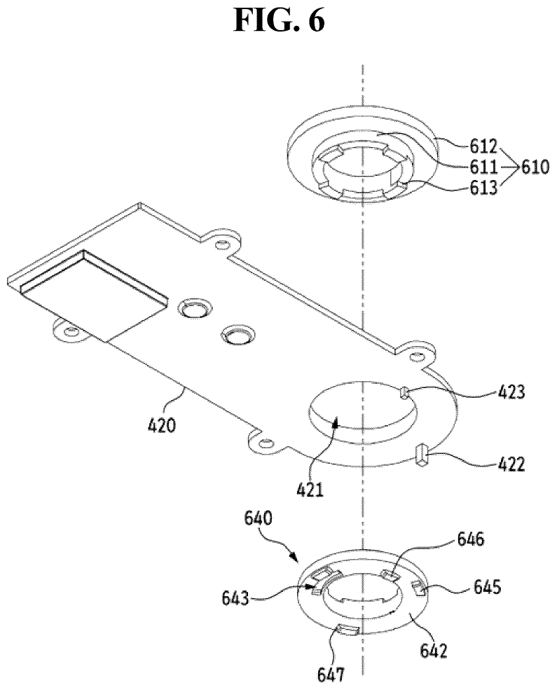

FIG. 3 is an exploded perspective view illustrating the vehicle camera module system illustrated in FIG. 2, FIG. 4 is a cross-sectional view, taken along line A-A′ in FIG. 2, of the vehicle camera module system illustrated in FIG. 2, FIG. 5 is an exploded top perspective view illustrating a driven gear, a lower cover, and a torque plate of the vehicle camera module system illustrated in FIG. 3, and FIG. 6 is an exploded bottom perspective view illustrating the driven gear, the lower cover, and the torque plate of the vehicle camera module system illustrated in FIG. 5.

Referring to FIGS. 3 through 6, the vehicle camera module system 10 may include a camera module 100, a base 200, a cover unit 300, a housing 400 of a motor 510, a driving unit 500, and a fixing module 600.

The base 200 may include a middle plate 210, a lower plate 220, and an upper plate 230.

The middle plate 210 may be formed of a metal material and may provide rigidity to support the cover unit 300 from the vehicle 1. A first side of the middle plate 210 may be fixed to the vehicle, and a fixing part 211 may be provided on a second side of the middle plate 210.

The fixing part 211 may be integrally formed with the middle plate 210 or may be assembled separately to the middle plate 210. The fixing module 600 may be coupled to the fixing part 211, and the fixing module 600 may be arranged to maintain fixed to the fixing part 211 or to rotate about the fixing part 211. The fixing part 211 may be formed in a substantially cylindrical shape and may protrude upward from the second side of the middle plate 210.

In addition, the lower plate 220 may be arranged to cover a surface of the middle plate 210. In this embodiment, the lower plate 220 is described, by way of example, as being arranged to cover a lower portion of the middle plate 210.

In addition, the upper plate 230 may be arranged to cover another surface of the middle plate 210. In this embodiment, the upper plate 230 is described, by way of example, as being arranged to cover an upper portion of the middle plate 210. That is, the lower and upper plates 220 and 230 may be joined or attached along a vertical direction to the middle plate 210 from above and below the middle plate 210, or may be formed by dual injection molding. The lower and upper plates 220 and 230 may include a synthetic resin material such as polycarbonate. In some embodiments, the lower and upper plates 220 and 230 may be configured to be joined to each other in a horizontal direction from both lateral sides of the middle plate 210.

A portion of the upper surface of the second side of the middle plate 210 where the fixing part 211 is disposed may be partially exposed through a first through-hole 231 formed in the upper plate 230.

The base 200 may be formed such that each of the middle, lower, and upper plates 210, 220, and 230 may have a thin plate shape, and the combined height of the lower and upper plates 220 and 230, excluding the fixing part 211, may be in a range of about 20 to 25 percent of the total height of the cover unit 300.

The cover unit 300 may include a lower cover 310 having a second through-hole 311, through which the fixing part 211 passes, and an upper cover 320 coupled to an upper portion of the lower cover 310 to form an overall exterior appearance.

The lower cover 310 may include a first region A1 that is in contact with the upper surface of a second side of the upper plate 230, and a second region A2 that is bent and extended from the first region A1 and is arranged to be at the same height as the lower plate 220.

The first region A1 may be arranged to at least partially overlap the upper plate 230 and may be formed to have the same width as the upper plate 230. The second through-hole 311 may be formed in the first region A1.

In addition, the second region A2 may be formed to have a relatively lower bottom position compared to the first region A1. That is, the first and second regions A1 and A2 may be arranged in a stepped configuration.

A connection region A3 may be formed between the first and second regions A1 and A2 as a curved surface to correspond to an arc shape formed at the distal end of a second side of the base 200. Here, the curved surface of the connection region A3 may be formed to correspond to a radial position such that the cover unit 300 may rotate about the fixing part 211 from the base 200 without interference.

Since the second region A2 is formed to have a relatively greater height than the first region A1, components such as the motor 510 of the driving unit 500 and the camera module 100 may be disposed inside.

The region of the upper cover 320 corresponding to the second region A2 of the lower cover 310 may be formed to have a relatively greater height. The upper cover 320 may further include a camera module cover 321 that covers the exterior of the region where the camera module 100 is mounted.

The motor 510 may be accommodated within the housing 400, which includes an upper housing 410 and a lower housing 420. In an electric mode, as the driving unit 500 arranged inside the housing 400 generates operational power, the housing 400 of the motor 510 may rotate in a folding or unfolding direction with respect to the fixing module 600 in an electric mode.

The upper housing 410 may have a third through-hole 411 formed on one side through which the fixing part 211 passes and may accommodate the driving unit 500 therein.

The lower housing 420 may have a fourth through-hole 421 formed on one side through which the fixing part 211 passes and may be coupled to a lower portion of the upper housing 410 to support rotation of the driving unit 500. A portion of the fixing module 600 to be described later may be disposed between the third through-hole 411 of the upper housing 410 and the fourth through-hole 421 of the lower housing 420.

The lower housing 420 may be formed to selectively interfere with the fixing module 600 in the folding direction depending on whether the folding is performed in electric mode or manual mode.

The driving unit 500 may provide actuation power for the housing 400 of the motor 510 to rotate in the folding direction about the fixing part 211. The driving unit 500 may include the motor 510 and a gear module 520. The motor 510 may be installed between the upper and lower housings 410 and 420. The gear module 520 may include a worm gear 521 coupled to the rotation shaft of the motor 510, a first reduction gear 522 engaged with the worm gear 521, a second reduction gear 523 engaged with the first reduction gear 522, and a third reduction gear 524 engaged with the second reduction gear 523 and with the fixing module 600. The rotational power (e.g., torque) generated by the driving unit 500 may be transmitted to the fixing module 600 to rotate the housing 400 of the motor 510 in the folding or unfolding direction in the electric mode.

In the manual mode, since the driving unit 500 may be disengaged from power transmission, and rotation of the gear module 520 is restricted, the cover unit 300 may rotate about the fixing part 211 along with the fixing module 600 in a folding, unfolding, or reverse-folding manner.

The fixing module 600 may be arranged (i) in the electric mode, to be fixed with respect to the fixing part 211 such that the housing 400 of the motor 510 rotates in the folding or unfolding direction by the power of the driving unit 500, and (ii) in the manual mode, to rotate together about the fixing part 211 when an external force is exerted on the cover unit 300.

The fixing module 600 may include a driven gear 610, a clip plate 620, a clip 621, an elastic member 630, and a torque plate 640.

The driven gear 610 may be installed inside the housing 400 of the motor 510 about the fixing part 211 and may be arranged to engage with the third reduction gear 524. The driven gear 610 may have a generally cylindrical shape and may include a first body 611 arranged to pass through the fixing part 211, and a gear part 612 radially protruding from one outer circumferential surface of the first body 611 to engage with the third reduction gear 524.

The clip plate 620 may be coupled to the upper side of the fixing part 211 via the clip 621 above the driven gear 610 to prevent the fixing module 600 from being separated from the fixing part 211.

The elastic member 630 may be installed between the clip plate 620 and the driven gear 610 through the fixing part 211. The elastic member 630 may be implemented as a wave spring. Thus, the elastic member 630 may provide elastic restoring force between the clip plate 620 and the driven gear 610.

An upper portion of the torque plate 640 may be arranged to contact and interfere with a lower portion of the first body 611 of the driven gear 610, and a lower portion of the torque plate 640 may be arranged to contact and interfere with the base 200. For example, the torque plate 640 may contact the middle plate 210 through the first and second through-holes 231 and 311.

The torque plate 640 may include a second body 641 configured to be penetrated by the fixing part 211 and a flange part 642 that protrudes in the radial direction from the second body 641.

One of the lower portion of the first body 611 or an upper portion of the second body 641 may include a protrusion 613 that protrudes toward the other thereof, and the other may include a groove 643 corresponding to the protrusion 613. In this embodiment, the protrusion 613 is described, by way of example, as being formed on the lower portion of the first body 611, and the groove 643 is described, by way of example, as being formed on the upper portion of the second body 641.

The protrusion 613 and the groove 643 may be arranged such that their contact surfaces along the circumferential direction of the driven gear 610 are aligned orthogonally to the circumferential direction of the driven gear 610. That is, the protrusion 613 and the groove 643 may couple the driven gear 610 and the torque plate 640 such that they are fixed and rotate together. Alternatively, the driven gear 610 and the torque plate 640 may be connected via a fastening structure or may be integrally formed.

The lower housing 420 may include a first stopper 422 and a second stopper 423.

The first stopper 422 may be configured to be inserted into a first arc-shaped guide groove 212 formed in the same shape on each of the middle and upper plates 210 and 230. The first stopper 422 may be arranged at an outer peripheral end of the lower surface of the lower housing 420.

The first guide groove 212 may be disposed radially outside the first through-hole 231, the first stopper 422 may be arranged to correspond to the first guide groove 212, and the movable range of the first stopper 422 may be restricted according to the range of the first guide groove 212. Here, the first stopper 422 may be inserted into the first guide groove 212 through the lower cover 310. At this time, the lower cover 310 may be formed with a hole 312 corresponding to the shape of the first stopper 422 to allow penetration of the first stopper 422.

For example, the first stopper 422 may be disposed in a middle region of the first guide groove 212 in the unfolded state. In the folded state of the cover unit 300, the first stopper 422 may move to one end of the first guide groove 212, and in a reverse-folded state of the cover unit 300, the first stopper 422 may move to the other end of the first guide groove 212.

In addition, the second stopper 423 may be configured to be inserted into the torque plate 640. An arc-shaped second guide groove 644 may be formed on the upper surface of the flange part 642 of the torque plate 640, and the second stopper 423 may be inserted into the second guide groove 644. When folding or unfolding occurs in the electric mode, the torque plate 640 may limit the rotation range of the second stopper 423 within the range of the second guide groove 644. The second guide groove 644 may be formed to have a smaller movable range than the first guide groove 212.

The first and second stoppers 422 and 423 may be respectively arranged in non-overlapping ranges in the circumferential direction of the driven gear 610. For example, the second stopper 423 may be disposed radially closer to the fourth through-hole 421 at the bottom of the lower housing 420 compared to the first stopper 422.

The torque plate 640 may include outer protrusions 645 that protrudes from an outer peripheral region of the lower surface of the flange part 642, and a first inner protrusion 646 that protrudes from a radial position disposed more inward than the outer protrusion 645.

The outer protrusions 645 may protrude from the lower surface of the flange part 642 and be arranged in the circumferential direction around the fixing part 211 at equal intervals. In this embodiment, three outer protrusions 645 are described, by way of example, as being provided to protrude at 120° intervals.

A plurality of outer grooves 213 may be formed in the middle plate 210 to correspond to the outer protrusions 645. In other words, the torque plate 640 may be arranged to contact the upper surface of the middle plate 210 around the fixing part 211. At this time, the torque plate 640 may be biased toward the middle plate 210 by the elastic restoring force of the elastic member 630.

In other words, the driven gear 610 and the torque plate 640 may be coupled so that the fixing part 211 passes through the driven gear 610 and the torque plate 640. Since there is no interfering structure in the folding or unfolding direction with respect to the outer circumferential surface of the fixing part 211, the driven gear 610 and the torque plate 640 may remain simply coupled to the fixing part 211. However, the torque plate 640 may be arranged to be pressed toward the middle plate 210, and as the outer protrusions 645 of the torque plate 640 are inserted into the outer grooves 213 of the middle plate 210, the driven gear 610 and the torque plate 640 relatively transmit the power of the driving unit 500 to the housing 400 of the motor 510 without a relative rotation in the folding or unfolding direction on the fixing part 211.

At this time, the outer protrusions 645 and the outer grooves 213 may be formed as inclined surfaces 647 such that the surfaces where the outer protrusions 645 and the outer grooves 213 contact in the circumferential direction of the torque plate 640 are inclined with respect to the circumferential direction of the torque plate 640. Accordingly, when the driving unit 500 is stopped and an external force is applied to the cover unit 300 to rotate in the folding or unfolding direction, the torque plate 640 may be displaced in a direction away from the middle plate 210 along the inclined surfaces 647 and may be arranged to rotate about the fixing part 211.

The first inner protrusion 646 may be arranged more radially inward than the outer protrusions 645 from the lower surface of the torque plate 640. The middle plate 210 may be formed with an inner groove 214 corresponding to the first inner protrusion 646. Thus, in a state in which the outer protrusions 645 are inserted into the outer grooves 213, the first inner protrusion 646 may be inserted into the inner groove 214.

In addition, the middle plate 210 may include a second inner protrusion 215 configured to interfere with the first inner protrusion 646 of the torque plate 640 during reverse rotation in the manual mode when the housing 400 of the motor 510 is in the unfolded state.

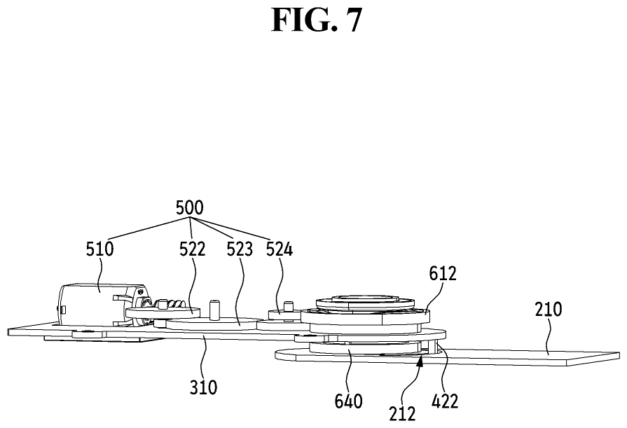

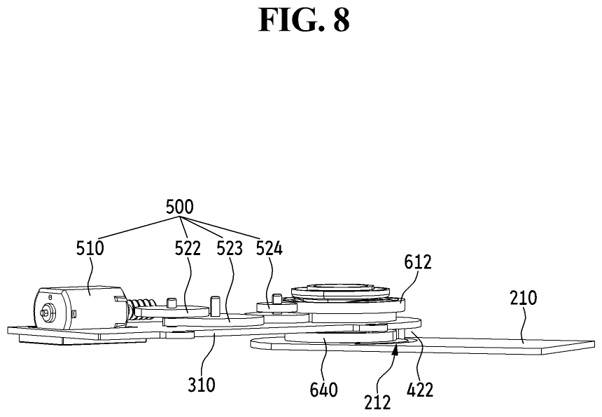

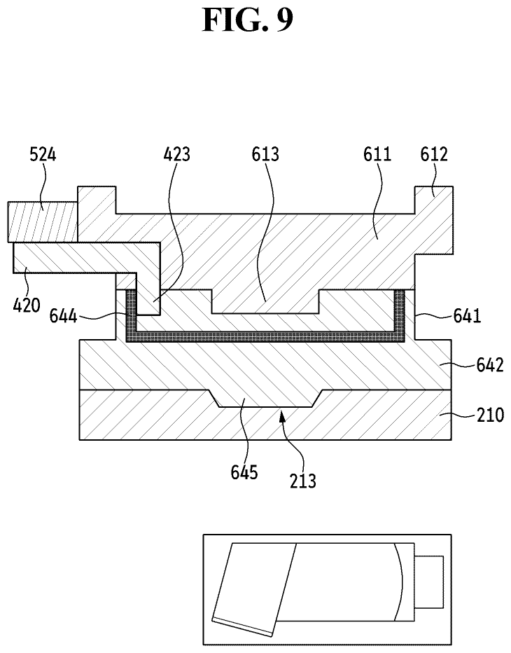

FIG. 7 is a perspective view illustrating an unfolded state of the vehicle camera module system in FIG. 2, with the cover unit removed for illustration purposes, FIG. 8 is a perspective view illustrating a partially folded state of the vehicle camera module system in FIG. 7 in the electric mode, and FIGS. 9 through 11 are cross-sectional views illustrating a folding process of the vehicle camera module system in FIGS. 7 and 8.

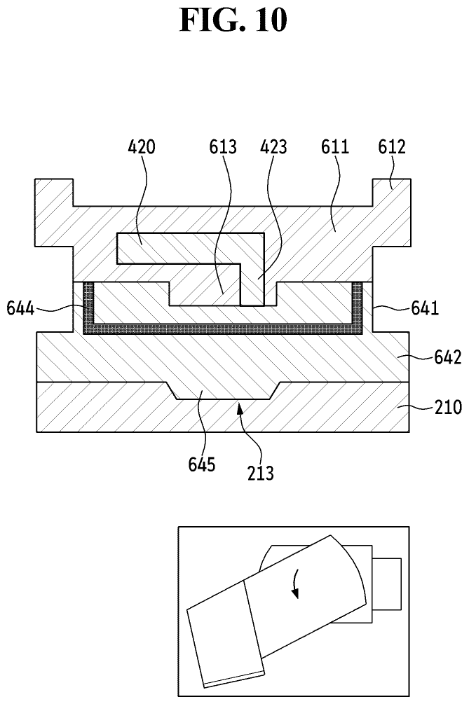

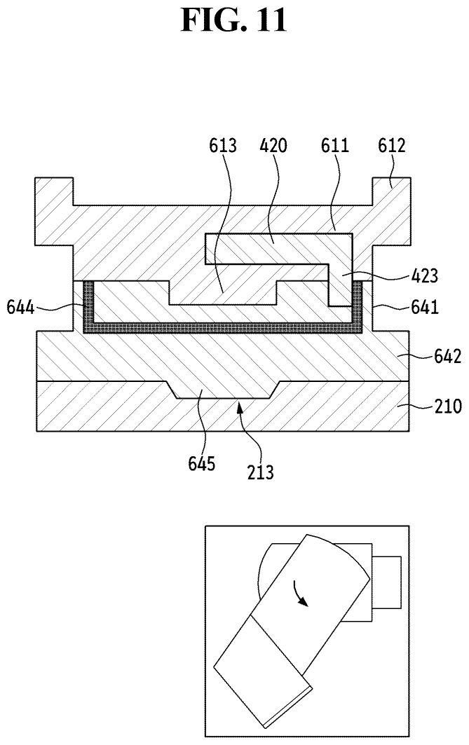

Referring to FIGS. 7 through 11, in the electric mode, folding and unfolding may be performed by the power of the driving unit 500. FIGS. 7 and 9 illustrate the unfolded state, FIGS. 8 and 10 illustrate the partially folded state, and FIG. 11 illustrates a completely folded state.

When electrical power is applied to the driving unit 500 to rotate in the folding direction from the unfolded state, as illustrated in FIG. 9, the third reduction gear 524 may rotate relative to the gear part 612 of the driven gear 610, and the lower housing 420 may be folded about the fixing part 211, as illustrated in FIG. 10. In this case, the second stopper 423 may move from one side to the other within the second guide groove 644. The rotation process from the folded state to the unfolded state in the electric mode may proceed in the reverse order.

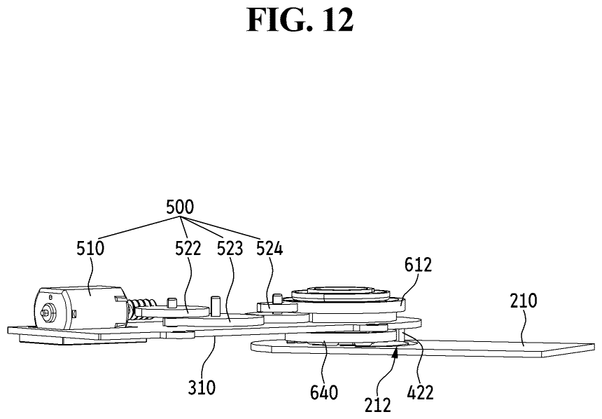

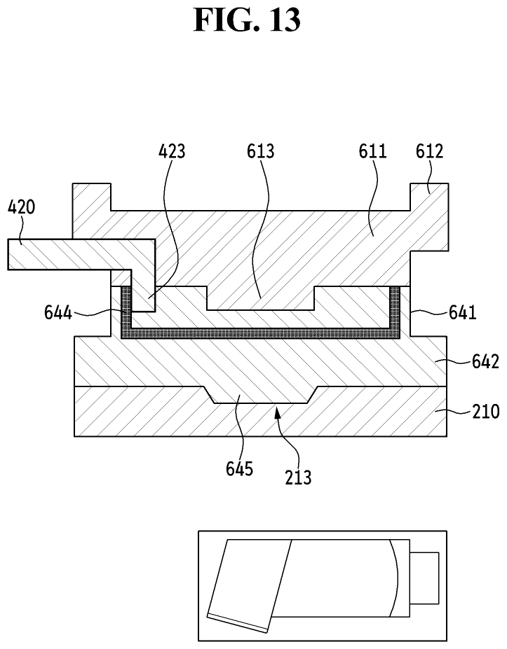

FIG. 12 is a perspective view illustrating a partially folded state of the vehicle camera module system in FIG. 7 in the manual mode, and FIGS. 13 through 15 are cross-sectional views illustrating a folding process of the vehicle camera module system in FIG. 12.

Referring to FIGS. 12 through 15, in the manual mode, folding or unfolding may be performed as the cover unit 300 is subject to an external force.

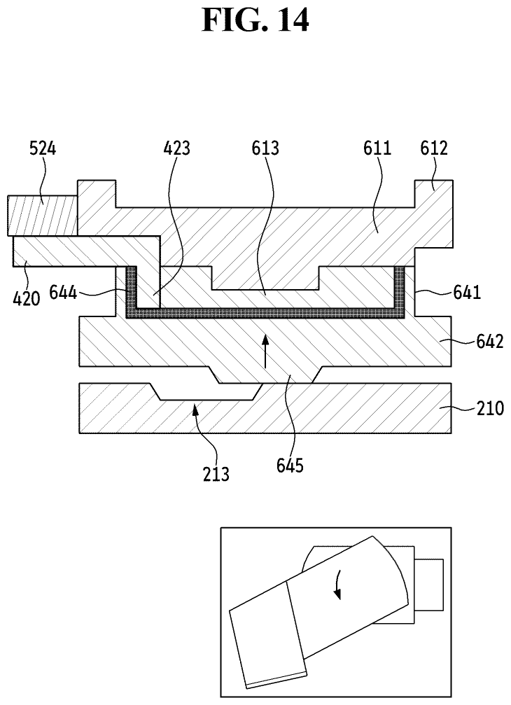

When an external force is applied in the folding direction (FIG. 14) from the unfolded state (FIG. 13), a rotational force in the folding direction is generated in the torque plate 640 due to the engagement between the protrusion 613 and the groove 643. This forward rotational force causes the torque plate 640 to be axially spaced apart from the middle plate 210, and to be lifted, together with the driven gear 610, about the fixing part 211. FIG. 14 illustrates a state in which the torque plate 640 and the driven gear 610 have rotated in the folding direction, and forced folding may be performed as slipping occurs between the upper surface of the middle plate 210 and the outer protrusions 645 of the torque plate 640.

At this time, the third reduction gear 524 may remain engaged with the gear part 612 of the driven gear 610, but may rotate only in the folding direction, and with the electric power from the driving unit 500 lost, rotation of each component of the gear module 520 may be restricted.

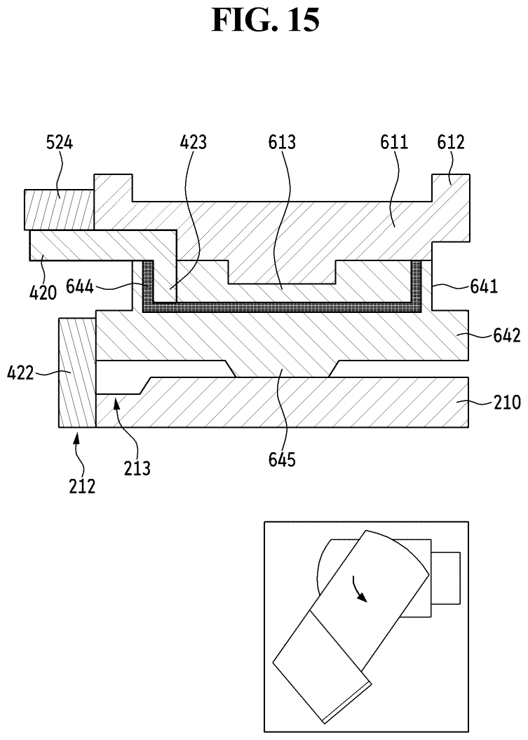

FIG. 15 illustrates a state in which folding is completed in the manual mode. At this time, further folding rotation in the manual mode may be restricted as the first stopper 422 interferes with one side of the first guide groove 212. The rotation process from the folded state to the unfolded state in the manual mode may proceed in the reverse order.

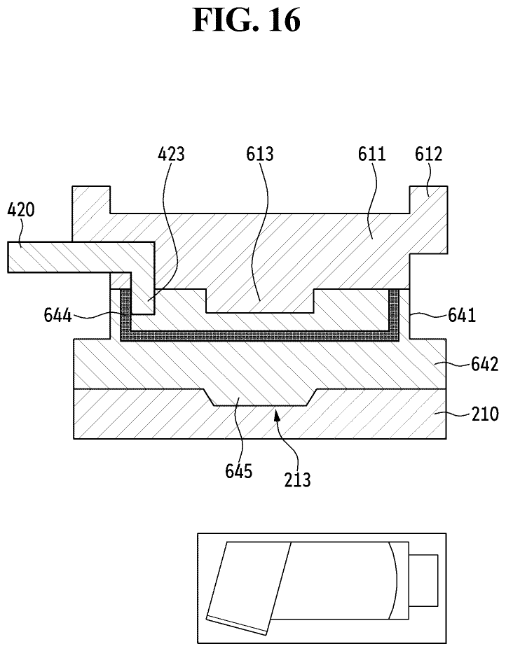

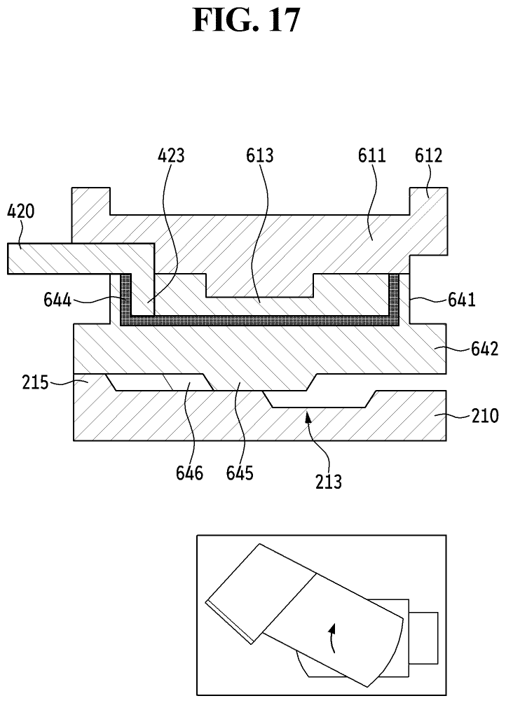

FIGS. 16 through 18 are cross-sectional views illustrating a reverse folding process of the vehicle camera module system from the unfolded state in the manual mode.

Referring to FIGS. 16 through 18, reverse folding indicates a state in which the rotation occurs in a direction opposite to the folding direction from the unfolded state. In other words, when reverse folding occurs in the manual mode, a rotational force may be generated in the torque plate 640 in a reverse folding direction due to the engagement between the second stopper 423 and the second guide groove 644. This reverse rotational force may cause the torque plate 640 to be spaced apart from the middle plate 210 and rotate in the reverse folding direction.

At this time, the first inner protrusion 646 may rotate toward the second inner protrusion 215 along the unfolding direction. When the first inner protrusion 646 abuts the second inner protrusion 215, interference may occur between the first inner protrusion 646 and the second inner protrusion 215, thereby restricting further reverse folding rotation of the torque plate 640.

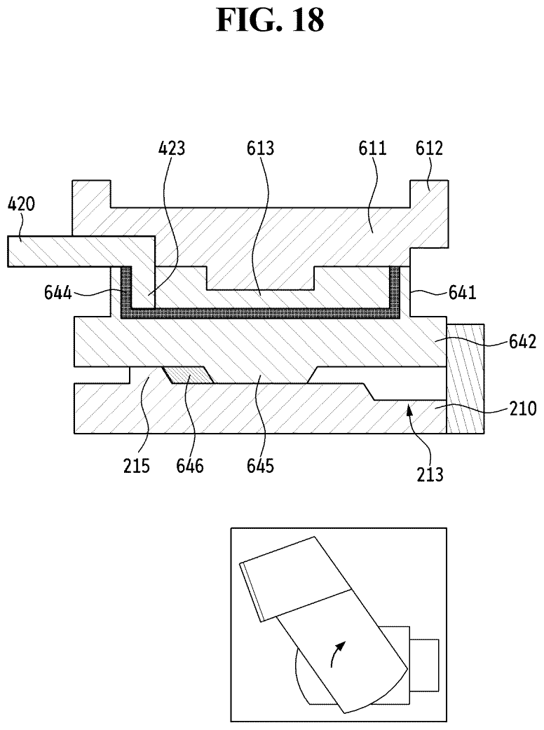

FIG. 18 illustrates a state in which reverse folding rotation is restricted as the first inner protrusion 646 and the second inner protrusion 215 come into contact with each other. Even in the state illustrated in FIG. 18, reverse folding rotation may be restricted as the first stopper 422 interferes with the other side of the first guide groove 212.

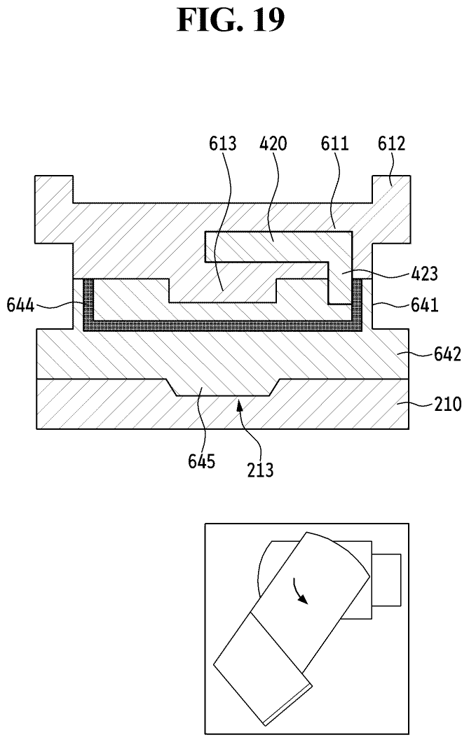

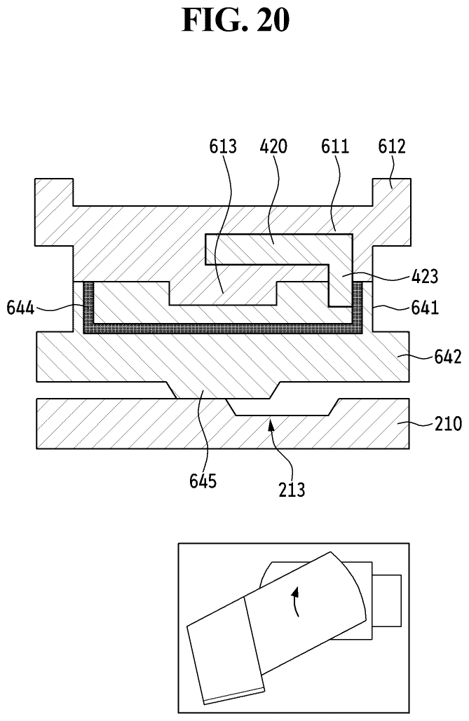

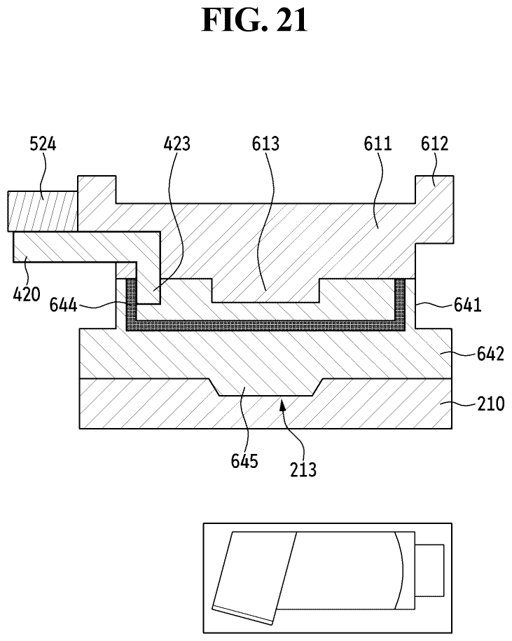

FIG. 19 is a cross-sectional view illustrating a folding process of the vehicle camera module system in FIG. 11 in the electric mode, FIG. 20 is a cross-sectional view illustrating an unfolding process of the vehicle camera module system in FIG. 19 in the manual mode, and FIG. 21 is a cross-sectional view illustrating a state in which the vehicle camera module system in FIG. 19 is aligned in the electric mode after being unfolded in the manual mode.

Referring to FIGS. 19 through 21, the vehicle camera module system 10 may be driven by a combination of the electric mode and the manual mode. For example, folding may be performed in the electric mode, and unfolding may be performed in the manual mode. In this case, folding in the electric mode may be performed through the process described above with reference to FIGS. 9 through 11.

Here, when folding is completed in the electric mode and unfolding is performed in the manual mode, the third reduction gear 524 and the gear part 612 of the driven gear 610 may be in a meshed state and may not rotate with respect to each other. Thus, when an unfolding rotation is generated in the cover unit 300 by an external force, interference may not occur between the second stopper 423 and the second guide groove 644, but unfolding rotation may occur by the driven gear 610 and the torque plate 640.

As the torque plate 640 may be displaced upward from the middle plate 210, unfolding rotation may occur, and even in a fully unfolded state, the torque plate 640 may remain displaced upward from the middle plate 210. In this unfolding process in the manual mode, unfolding rotation may also be restricted as the first inner protrusion 646 and the second inner protrusion 215 come into contact with each other.

After unfolding is completed in the manual mode, in order to realign the torque plate 640 to its base position, rotation in the folding direction may be performed in the electric mode to allow the torque plate 640 to be aligned and to be in close contact with the middle plate 210.

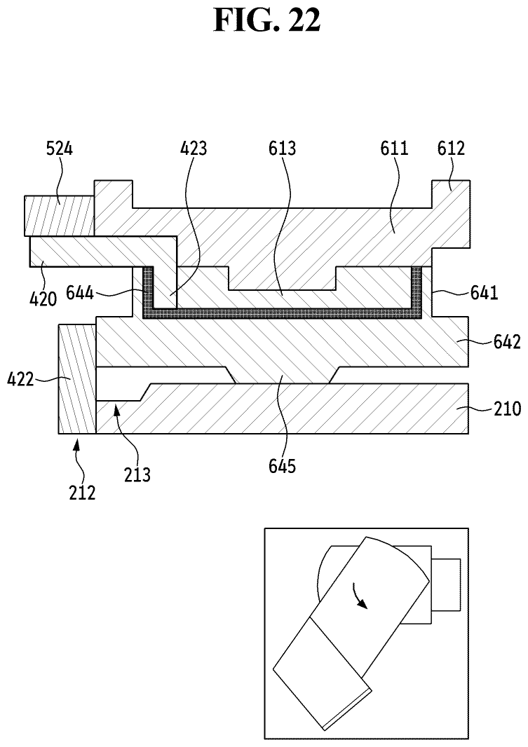

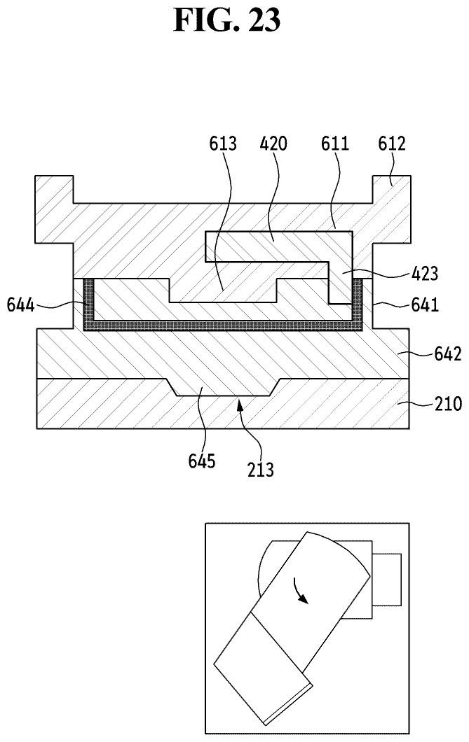

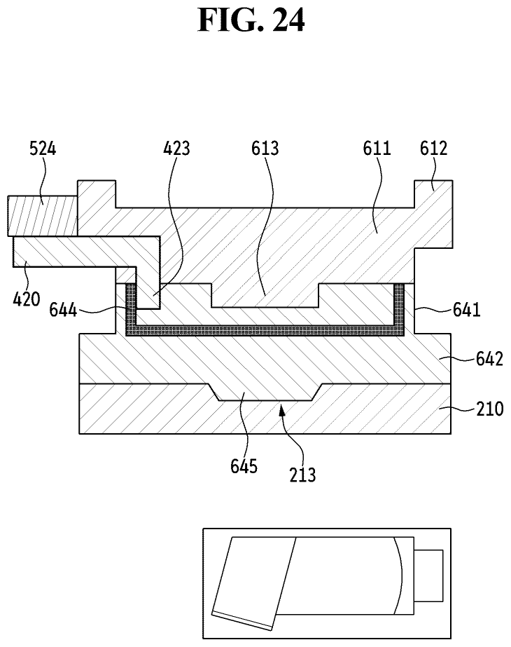

FIG. 22 is a cross-sectional view illustrating a folding process of the vehicle camera module system in FIG. 15 in the manual mode, FIG. 23 is a cross-sectional view illustrating a state in which the vehicle camera module system in FIG. 22 is aligned in the electric mode, and FIG. 24 is a cross-sectional view illustrating an unfolding process of the vehicle camera module system in FIG. 23 in the electric mode.

Referring to FIGS. 22 through 24, for example, folding may be performed in the manual mode, and unfolding may be performed in the electric mode. In this case, folding in the manual mode may be performed through the process described above with reference to FIGS. 13 through 15.

Here, when folding is completed in the manual mode and unfolding is performed in the electric mode, the third reduction gear 524 may rotate the driven gear 610 so that the torque plate 640 moves to its base position with respect to the middle plate 210, and when the torque plate 640 and the driven gear 610 are fixed on the middle plate 210 and power continues to be transmitted from the driving unit 500, the housing 400 of the motor 510 may rotate relative to the fixing module 600, thereby completing unfolding in the electric mode.

Therefore, according to the vehicle camera module system of the present disclosure, aesthetic appearance can be enhanced by configuring the portion that protrudes from the vehicle or the door of the vehicle to have a slim design. Additionally, a folding structure can be included while maintaining a slim structure. Further, automatic alignment to the reference position, which is the unfolded state, can be achieved while being driven in both the electric and manual modes. Also, by improving the vehicle camera module system to have a slim form factor, effects such as reduction of wind noise, improvement in fuel efficiency, and improvement in electric efficiency can be achieved.

While the technical idea of the present disclosure has been illustrated and described in detail with reference to specific embodiments, the present disclosure is not limited to the specific configurations and operations of these embodiments. Various modifications can be made within the scope of the disclosure without departing from its spirit. Therefore, such modifications should be considered within the scope of the disclosure, and the scope of the disclosure should be determined by the appended claims.

What is claimed is:

1. A vehicle camera module system comprising:
a base, a first side of which is connected to a vehicle and a second side of which includes a fixing part that forms a rotation shaft;
a cover unit including a lower cover arranged such that a first side thereof is penetrated by the fixing part, and an upper cover coupled to an upper portion of the lower cover;
a camera module provided at a second side of the cover unit;
a motor housing disposed in the cover unit and penetrated by the fixing part, wherein the motor housing is arranged to be rotatable within a predetermined angular range with respect to the base;
a driving unit that provides power to cause relative rotation of the motor housing about the fixing part; and
a fixing module configured to:
(i) in an electric mode, be fixed to the fixing part to allow the relative rotation of the motor housing with respect to the fixing module in response to the power of the driving unit being transmitted; and
(ii) in a manual mode, rotate with the motor housing about the fixing part in response to an external force being exerted.

2. The vehicle camera module system of claim 1, wherein the driving unit comprises:
a motor that generates a rotational power; and
at least one gear module to transmit the rotational power.

3. The vehicle camera module system of claim 2, wherein the fixing module comprises:
a driven gear disposed inside the motor housing and penetrated by the fixing part, and configured to engage with the at least one gear module;
a clip plate arranged to be penetrated by an end of the fixing part;
a clip that fixes the clip plate to the end of the fixing part; and
an elastic member disposed between the driven gear and the clip plate to bias the driven gear toward the base.

4. The vehicle camera module system of claim 3, wherein the fixing module further includes a torque plate arranged outside the motor housing and coupled with the driven gear.

5. The vehicle camera module system of claim 4, wherein one of the torque plate or the driven gear includes a protrusion that protrudes toward the other thereof, and
wherein the other includes a groove corresponding to the protrusion.

6. The vehicle camera module system of claim 5, wherein the protrusion and the groove are arranged such that their contact surfaces lie in a direction orthogonal to a circumferential direction of the driven gear.

7. The vehicle camera module system of claim 5, wherein the motor housing includes:
a lower housing arranged below the driving unit; and
an upper housing coupled to the lower housing to surround the driving unit between the lower housing and the upper housing.

8. The vehicle camera module system of claim 7, wherein the lower housing includes a first stopper that protrudes to be inserted into the base and disposed near a through-hole, which is penetrated by the fixing part, formed in the lower housing.

9. The vehicle camera module system of claim 8, wherein the base includes:
a middle plate from which the fixing part protrudes upward; and
a lower plate and an upper plate that accommodates the middle plate therebetween.

10. The vehicle camera module system of claim 9, wherein the upper plate or both the upper plate and the middle plate includes an arc-shaped first guide groove into which the first stopper is movably inserted, to restrict rotation of the motor housing within a predetermined angular range along the first guide groove.

11. The vehicle camera module system of claim 10, wherein the lower housing includes a second stopper that protrudes to be inserted into the torque plate and disposed near the through-hole formed in the lower housing.

12. The vehicle camera module system of claim 11, wherein the torque plate includes a second guide groove formed in an outer peripheral region of an upper surface thereof, wherein the second guide groove is configured to limit a rotation range of the second stopper within a predetermined angular range when the motor housing is rotated in the electric mode.

13. The vehicle camera module system of claim 12, wherein the first stopper and the second stopper are respectively arranged in non-overlapping ranges in a circumferential direction of the driven gear.

14. The vehicle camera module system of claim 12, wherein the first guide groove is formed to have the predetermined angular range that is greater than the second guide groove.

15. The vehicle camera module system of claim 12, wherein the torque plate comprises:
a plurality of outer protrusions that protrude from an outer peripheral region of a lower surface of the torque plate at substantially equal intervals along a circumferential direction of the driven gear; and
a first inner protrusion that protrudes from the lower surface at a radial position more inward than the outer protrusions.

16. The vehicle camera module system of claim 15, wherein the middle plate comprises:
a plurality of outer grooves corresponding to the outer protrusions; and
an inner groove corresponding to the first inner protrusion.

17. The vehicle camera module system of claim 16, wherein the outer protrusions and the outer grooves are formed with inclined surfaces such that their contact surfaces are inclined with respect to the circumferential direction.

18. The vehicle camera module system of claim 17, wherein when the cover unit is rotated in the manual mode, the torque plate is configured to be elastically spaced apart from the middle plate along the inclined surfaces, and to rotate about the fixing part together with the motor housing and the driven gear.

19. The vehicle camera module system of claim 16, wherein the middle plate includes a second inner protrusion configured to interfere with the first inner protrusion in a process in which the motor housing is rotated in a reverse folding direction from an unfolded state in the manual mode.

20. The vehicle camera module system of claim 19, wherein the first guide groove is formed to have the predetermined angular range that is greater than the second guide groove by a range corresponding to an angular movement range of the first stopper in the reverse folding direction, which is opposite to a folding direction, from an unfolded state of the motor housing.
